(19) United States
(12) Patent Application Publication
(10) Pub. No.: US 2024/0067759 A1
(43) Pub. Date: Feb. 29, 2024

(54) IMPROVED METHOD FOR THE PREPARATION OF COLLOIDAL MICROCRYSTALLINE CELLULOSE

(71) Applicant: NUTRITION & BIOSCIENCES USA 1, LLC, Rochester, NY (US)

(72) Inventors: Oliver Petermann, Bomlitz (DE); Rene Kelling, Bomlitz (DE); Olena Vozniuk, Bomlitz (DE); Stefan Junge, Bomlitz (DE); Michael Schreck, Bomlitz (DE); Jing G. Guo, Rochester, NY (US); Matthias R. Sprehe, Bomlitz (DE)

(21) Appl. No.: 18/261,304

(22) PCT Filed: Jan. 12, 2022
(86) PCT No.: PCT/EP2022/050564

§ 371 Date: Jul. 13, 2023

Related U.S. Application Data
(60) Provisional application No. 63/136,707, filed on Jan. 13, 2021.

(51) Int. Cl. C08B 15/02; B01J 13/00

(52) U.S. Cl. CPC C08B 15/02; B01J 13/0086

(57) ABSTRACT

A mill dried colloidal microcrystalline cellulose (MCC) is obtained in a process comprising the steps of a) providing colloidal MCC having a moisture content of from 20 to 75 percent, based on the total weight of the moist colloidal MCC; and b) mill-drying the moist colloidal MCC in a single device capable of milling and drying in combination. The process can provide mill-dried colloidal microcrystalline cellulose having similar particle size distribution (LEFI, DIFI and EQPC), and a similar or higher tapped/untapped bulk density, a similar or lower Carr index, a similar or higher viscosity and a similar moisture content as the corresponding spray-dried colloidal microcrystalline cellulose.

### FIELD

The present invention relates to a new process for producing dried colloidal microcrystalline cellulose (colloidal MCC), to colloidal MCC producible by the new process and to colloidal MCC having new properties.

### INTRODUCTION

Microcrystalline cellulose (MCC) is a purified product which is produced by converting fibrous cellulose into a highly crystalline cellulose by selective hydrolytic degradation of amorphous regions of the fibrous cellulose. The sources for the preparation of MCC can be cellulose pulp from fibrous plants materials such as wood or other cellulosic materials such as cotton from linters, stalks, rags or fabric waste. MCC products are used as binders and disintegrants in pharmaceutical tablets and as suspending liquids in pharmaceutical formulations. MCC is widely used as a binder, gelling agent, thickener, texturizer, stabilizer, emulsifier and as fat replacement in food and beverage applications. Moreover, MCC products find use as for example binders or bulking agents in personal care applications, such as cosmetics and dentifrices, or as a binder, bulking agent, disintegrant or processing aid in cosmetics and dentifrices, in industrial applications such as in paint, in household products such as detergents or bleach tablets, and in agricultural formulations.

The classical method for MCC production, which is still the most common manufacturing method, is acid hydrolysis of purified cellulose as for example disclosed in U.S. Pat. No. 2,978,446.

Other processes for the preparation of microcrystalline cellulose have been developed such as steam explosion (U.S. Pat. No. 5,769,934), reactive extrusion (U.S. Pat. No. 6,228,213), high temperature reaction in a reactor pressurized with oxygen and/or carbon dioxide gas (U.S. Pat. No. 5,543,511).

Following the acidic hydrolysis, microcrystalline cellulose is separated from the reaction mixture to provide a wetcake.

For producing colloidal MCC, the MCC wetcake is subjected to an attrition process, for example extrusion, that substantially subdivides the aggregated cellulose crystallites into more finely divided crystallite particles. To prevent hornification, a protective hydrocolloid, e.g a hydrophilic co-polymer, may be added before, during or following attrition, but before drying. The protective hydrocolloid, wholly or partially, screens out the hydrogen bonds or other attractive forces between the smaller sized particles to provide a readily dispersible powder. Colloidal MCC will typically form stable suspensions with little or no settling of the dispersed solids as for example described in WO2018236965. Carboxymethyl cellulose is a common hydrocolloid used for these purposes, as for example described in U.S. Pat. No. 3,539,365 and WO2018031859. Alginates, pectins, carrageenan may be used as hydrocolloid as for example described in WO2019050598 or WO2013085809. Colloidal MCC products are for example available under the brand names Avicel® and Gelstar®. An important application for colloidal MCC is stabilization of suspensions, e.g. suspensions of solid particles in low viscosity liquids, for example in beverages, such as chocolate milk. In food applications, for example in canned food, shell-stable spreads and salads, frozen desserts, aerosol toppings, meat, dairy and bakery products, colloidal MCC may be used as fat replacement or bulking agent, that is as a non-caloric filler or texture modifier. In pharmaceutical—and personal care applications, such as eye drops, ointments, suspensions and gels, colloidal MCC can be used as a rheology or texture modifier.

A final step in manufacturing of colloidal MCC is drying of the MCC-hydrocolloid wet-cake. In commercial manufacturing the drying-step is commonly performed by spray-drying [G. Thorens, Int. J. Pharm. (2015), 490, 47-54]. The desired commercial grades of MCC or colloidal MCC are obtained by varying and controlling the spray drying conditions in order to manipulate the degree of agglomeration (particle size distribution) and moisture content. [G. Thorens, Int. J. Pharm. (2015), 490, 47-54; G. Thorens, Int. J. Pharm. (2014), 473, 64-72)]. However, spray-drying can only be performed on slurries having a high water-content and therefore the MCC wet-cake must be diluted with water prior to spray-drying. An aqueous slurry of MCC for spray drying typically consists of ca. 10-20% MCC or colloidal MCC and 80-90% water. Spray drying of MCC or colloidal MCC is therefore associated with very high energy expenses due to the large amount of water to be evaporated. Furthermore, spray-drying equipment is very costly.

Thus, there is a need for a cost-efficient method for drying a colloidal microcrystalline cellulose wet-cake. Particularly there is a need for cost-efficient methods for drying a colloidal microcrystalline cellulose wet-cake in an industrial scale while retaining favorable properties of the dried colloidal microcrystalline cellulose product, such as favorable particle size, particle morphology, bulk density, flowability, moisture content and viscosity. Particularly, there is a need for colloidal MCC having a favorable viscosity, such as increased viscosity.

### SUMMARY

In one aspect the present invention relates to a process for producing mill dried colloidal microcrystalline cellulose (MCC) comprising the steps of a) providing colloidal MCC having a moisture content of from 20 to 75 percent, based on the total weight of the moist colloidal MCC, and b) mill-drying the moist colloidal MCC in a single device capable of milling and drying in combination.

In another aspect the present invention relates to colloid microcrystalline cellulose producible by the process described above.

In yet another aspect the present invention relates to colloidal microcrystalline cellulose wherein said colloidal MCC has a moisture content of less than 20% by weight, based on the total weight of the colloidal MCC including moisture, and wherein said colloidal microcrystalline cellulose has a ratio (initial viscosity):(24 h viscosity), measured as 2 weight-% dispersion in water at 20° C. at a shear rate of 2.51 s-1, of at least 0.4.

In a further aspect the present invention relates to use of a colloidal microcrystalline cellulose according to the embodiments above in food or beverage applications, in pharmaceutical applications or in personal care applications.

The present inventors have found that colloidal microcrystalline cellulose having a moisture content of 20-75%, based on the total weight of the moist colloidal MCC, can be subjected to drying and milling in combination in a single mill-drying device to provide mill dried colloidal MCC. According to the process of the present invention mill dried colloidal MCC can be produced that has a particle sizes (LEFI, DIFI and/or EQPC) that are taylor-made according to the needs of the particular end-uses. The process of the present invention enables control of the morphology of the mill dried colloidal MCC and the production of mill dried colloidal MCC having a variety of particle sizes in the colloidal range.

In one aspect of the invention, mill dried colloidal MCC can be produced that exhibits comparable particle sizes (LEFI, DIFI and/or EQPC) as well as comparable or improved viscosity, bulk density and/or Carr index compared to colloidal microcrystalline cellulose prepared by traditional spray-drying of colloidal microcrystalline cellulose slurry having a water content of ca. 80-90%. Particularly, mill-drying of colloidal microcrystalline cellulose according to the process of the present invention can provide mill-dried colloidal microcrystalline cellulose having similar particle sizes (LEFI, DIFI and/or EQPC) and moisture content as the corresponding spray-dried colloidal microcrystalline cellulose prepared by traditional spray-drying of microcrystalline cellulose slurry having a water content of ca. 80-90%. In another aspect of the invention, mill-dried colloidal MCC can be produced having coarser particles than colloidal MCC prepared by traditional spray-drying of colloidal microcrystalline cellulose slurry having a water content of ca. 80-90%.

In a preferred aspect of the invention, the process of the present invention enables the production of mill dried colloidal MCC that surprisingly has an improved, that is a higher, viscosity than spray-dried colloidal MCC, which may lead to a reduced use-level of the colloidal MCC, i.e. reduce the amount of colloid needed in, for example, food products. Surprisingly, the process of the present invention enables the production of mill dried colloidal MCC that exhibits comparable particle sizes (LEFI, DIFI and/or EQPC) as well as improved viscosity compared to microcrystalline cellulose prepared by spray-drying.

The present invention allows for drying of a non-diluted wet-cake of MCC-hydrocolloid as opposed to traditional spray-drying of colloidal MCC which requires dilution of the MCC-hydrocolloid wet-cake to a moisture content of ca. 80%-90%. The reduced water content of the moist MCC-hydrocolloid leads to reduction in energy-consumption for drying, i.e., the present invention leads to substantial energy savings for the drying of colloidal MCC. In addition to reducing energy expenses for drying the colloidal MCC, the mill-drying equipment required for performing the present invention is generally cheaper and less space-consuming than spray-drying equipment for drying colloidal MCC, leading to reduced capital investment for performing the present invention, as compared to the traditional spray-drying method.

### DETAILED DESCRIPTION OF THE INVENTION

As used herein, “aggregated MCC” means MCC prior to attrition, and “attritted MCC” means MCC after attrition.

The term “colloidal MCC” is known in the art, see, e.g. International Patent application WO 94/24866. “Colloidal MCC” designates MCC in such a fine particle form that it behaves as a colloid in an aqueous system. E.g., MCC particles may have been attrited to the point where they are small enough to permit the MCC particles to function like a colloid, especially in an aqueous system. U.S. Pat. No. 6,037,380 describes colloidal MCC as particulate microcrystalline cellulose compositions which may be i) dispersed to form suspensions or ii) dried and the resulting particulate solid dispersed in liquid media to produce a suspension.

In the suspension, substantially all microcrystalline cellulose particles are of less than 1 micrometer in size and remain in a colloidal state even when centrifuged. In its preferred embodiment, “colloidal MCC” means MCC after co-processing, for example co-attrition, of MCC with an attriting aid, such as an acid or an inorganic salt and/or with a protective colloid, such as one or more polysaccharides.

The term “attrited” and “attrition” are used interchangeably to mean a process that effectively reduces the size of at least some, if not all, of the particles by application of high shear forces. The term “particles” as used herein includes, among others, the individual particles as well as clusters of particles, often referred to as “aggregates”.

The term “co-attrition” refers to the application of high shear forces to an admixture of the MCC and an attriting aid, such as an acid or an inorganic salt and/or a protective colloid, such as one or more one polysaccharides. Suitable attrition conditions may be obtained, for example, by co-extruding, milling or kneading.

“Co-processing” of the MCC with an attriting aid, such as an acid or an inorganic salt and/or with a protective colloid, such as one or more polysaccharides, may, for example, mean co-attrition, of the MCC with an attriting aid, such as an acid or an inorganic salt and/or with a protective colloid, such as one or more polysaccharides.

Microcrystalline cellulose (MCC) is a white, odorless, tasteless, relatively free flowing crystalline powder. It is a purified, partially depolymerized cellulose obtained by subjecting alpha cellulose obtained as pulp from fibrous plant material to hydrolytic degradation, typically with mineral acids. Suitable plant material includes, for example, wood pulp such as bleached sulfite and sulfate pulps, corn husks, bagasse, straw, cotton, cotton linters, flax, kemp, ramie, fermented cellulose, etc. During acidic hydrolysis the amorphous regions (or paracrystalline regions) of the cellulosic fibril are selectively hydrolysed while the crystalline regions remain intact, whereby highly crystalline particulate cellulose consisting mainly of crystalline aggregates (MCC) are obtained. The degree of polymerization (DP, the number of anhydroglucose units in the cellulose chain) decreases during the acid hydrolysis and the rate of hydrolysis slows to a certain level-off degree of polymerization (LOPD), typically 200-300. The MCC is separated from the reaction mixture and washed to remove degraded by-products.

After the washing step the MCC wet cake generally has a moisture content of from 35 to 70 percent, typically from 45 to 60 percent, based on the total weight of the moist MCC.

Preferred washing liquors generally are water, brine, or organic solvents in admixture with water, such as aqueous mixtures of isopropanol, ethanol or methanol. More preferred washing liquors generally are water or brine. Preferably MCC obtained directly after hydrolysis, washing and optionally cooling is used as a starting material for the present invention. MCC is generally washed at a temperature of from 10 to 80° C., preferably from 15 to 50° C. A solvent-moist, preferably a water-moist mass is obtained after washing and separating the MCC from the washing liquor. Separating MCC from a suspension can be carried out in a known way, such as centrifugation. The resulting wet mass is referred to in the art by several names, including hydrolyzed cellulose, hydrolyzed cellulose wetcake, level-off DP cellulose, microcrystalline cellulose wetcake or simply wetcake.

Wet MCC, such as MCC wet-cake, may be co-processed, such as co-attrited, with a hydrophilic copolymer, such as a polysaccharide, to form a mixture of MCC and hydrophilic copolymer.

The thus obtained moist mixture of MCC and hydrophilic copolymer, i.e. the moist colloidal MCC, is subsequently subjected to mill drying in a mill drying device according to the process of the present invention to produce mill dried colloidal MCC.

MCC can be co-processed, particularly co-attrited, with suitable polysaccharides, which may be cellulose derivatives such as cellulose ethers, for example carboxymethyl cellulose (CMC), hydroxypropyl methylcellulose (HPMC) or methylcellulose (MC); or cellulose ether esters; or polysaccharides which may be isolated from plant exudates as from for example gum Arabic, gum ghatti, gum karaya, gum tragacanth; plant seeds such as starches, locust bean gum, guar gum; seaweed polysaccharides such as agar, carrageenan, furcelleran and alginates; microbial and/or fermentation products such as dextran, xanthan, pullulan, gellan gums; or pectins. In an aspect of the invention the cellulose ether which is co-processed with MCC is carboxymethyl cellulose (CMC). Useful types of carboxymethyl cellulose (CMC) include their salts, preferably their sodium and potassium salts. The CMC is typically used in the form of its sodium salt. In the present context, the term ‘CMC’ is intended to include carboxymethyl cellulose and/or salts of CMC, such as sodium CMC or potassium CMC. The degree of substitution DS, which is the degree of carboxymethyl substitution DS (carboxymethyl), also designated as the degree of the carboxymethoxyl substitution DS (carboxy methoxyl), of the cellulose ether is the average number of OH groups substituted with carboxymethyl groups per anhydroglucose unit. Preferred types of CMC have a DS of at least 0.5, such as at least 0.6, such as at least 0.65. Preferred types of CMC have a DS of up to 1.2, such as up to 1.0, such as up to 0.95. The DS is measured according to ASTM D 1439-03 “Standard Test Methods for Sodium Carboxymethylcellulose; Degree of etherification, Test method B; Non-aqueous Titration”, which is performed as follows: The treatment of a solid sample of the CMC with glacial acetic acid at boiling temperature releases an acetate ion quantity equivalent to the sodium carboxymethyl groups. These acetate ions can be titrated as a strong base in anhydrous acetic acid using a perchloric acid standard solution. The titration end point is determined potentiometrically. Other alkaline salts of carboxylic acids (e.g. sodium glycolate and di-sodium diglycolate) behave similarly and are co-titrated.

Preferred types of CMC have a viscosity of at least 5 mPa·s, such as least 10 mPa·s, such as least 15 mPa·s, such as least 25 mPa·s, such as least 30 mPa·s, measured as a 2% by weight solution in water. Preferred types of CMC have a viscosity of up to 6000 mPa·s, such as up to 3100 mPa·s, such as up to 800 mPa·s, such as up to 100 mPa·s, such as up to 80 mPa·s, measured as a 2% by weight solution in water at 20° C. The viscosity of CMC is measured as a 2% by weight solution in water at 20° C. and at a shear rate of 2.55 s⁻¹ using a Haake VT550 Viscotester according to the following method: A 2% by weight solution was prepared:196.0 g deionized water (water in CMC is subtracted) was placed in 250 ml screw cap bottle. 4 g (dry weight) of the CMC was added onto the surface. After closing the bottle, it was vigorously shaken and placed on a rolling device until a clear solution was obtained (48 h). Afterwards the solution was allowed to settle without stirring/rolling over night. The viscosity was analyzed using a Haake VT550 Viscotester at 20° C. (+/−0.1° C.) and at a shear rate of 2.55 s⁻¹. The MV DIN sensor and the MV cup was used. The solution of the CMC was filled in the cup until the ring was reached. The solution was pretempered at a 20° C. water bath. After the system was closed the solution was tempered for 3 min without shearing, then the analysis was started. After shearing for 110 sat 2.55 s⁻¹ 15 data points were taken and averaged in 20 s.

Preferred types of Sodium CMC have a DS of 0.65 to 0.85 and a viscosity of 30 to 80 mPa*s, measured as a 2% by weight solution in water at 20° C.

Attrition may for example be accomplished by extrusion or with other mechanical devices such as refiners, planetary mixers, colloidal mills, beat mills, kneaders and grinders that can provide effective shearing force.

In the process of the present invention the mill-drying of colloidal MCC is conducted in a single device that is capable of milling and drying in combination. Such a device is herein designated as “mill-drying device”. In mill-drying devices milling and drying is done in combination, preferably at least partially simultaneously. Mill-drying devices are clearly distinct in function and design from devices that only serve for drying of material. E.g., the energy input into the drying devices essentially consists of thermal energy. However, mechanical energy and thermal energy are both put into mill-drying devices to a significant degree. The term “mechanical energy” as used herein means the energy, typically the electrical energy, that is required to put and keep the mill-drying device in operation, e.g., in rotational motion. The term “thermal energy” is the energy provided by the pre-heated drying gas that is fed into mill-drying device. In the process of the present invention, the mill-drying device is typically operated at an input of mechanical energy of from 2 to 100 percent, preferably from 5 to 50 percent, more preferably from 7 to 31 percent, based on the total of mechanical and thermal energy input.

A mill-drying device useful in the process of the present invention typically comprises a mill-drying chamber which is equipped with one or more inlets for the moist colloidal MCC and gas and with one or more grinding inserts, such as grinding pins, rods, bars, plates or disks. The grinding inserts are generally in movement, preferably in rotational movement, when the mill-drying chamber is in operation and accomplish milling of the colloidal MCC by impact and/or shearing. Drying is typically accomplished with a combination of hot gas and mechanical energy. Hot air is most commonly used but also hot nitrogen gas can be used. The hot gas and the moist colloidal MCC can be fed via separate inlets into the mill-drying chamber, typically hot gas from the bottom and moist colloidal MCC at a side entrance via a feed screw system connected to the mill-drying chamber. Alternatively, the moist colloidal MCC can be fed into the gas stream and subsequently via the gas stream into the mill-drying chamber. Depending on the position of the inserts in the mill-drying chamber, the moist colloidal MCC can first be partially dried before it is milled, or the moist colloidal MCC can first be partially milled before it is dried, or milling and drying can be conducted simultaneous. However, it is essential that milling and drying is conducted in a single device wherein milling and drying is done in combination.

Mill-drying of the moist colloidal MCC can be conducted in a known mill-drying device, for example in an impact mill, preferably a gas-swept impact mill, more preferably an air-swept impact mill, wherein colloidal MCC is subjected to an impacting and/or shearing stress as well as to drying.

Particle size, particle morphology, bulk density and flowability of the mill dried colloidal MCC can be controlled and/or adjusted by the design and/or operation of the mill-drying device, such as the type and number of grinding inserts like grinding pins, rods, bars, plates or disks or the circumferential speed of the mill-drying chamber. The larger the number of grinding inserts is in a given mill-drying chamber and/or the higher the circumferential speed of a given mill-drying chamber is, the smaller are generally the median particle sizes of the mill dried colloidal MCC, such as the median LEFI, DIFI and EQPC described further below. Preferred designs and operations of the mill-drying device are described in more detail below and in the examples.

Preferred air-swept impact mills are Ultra Rotor mills (Altenburger Maschinen Jaeckering, Germany), Contra-Selector PPS (PALLMANN Maschinenfabrik GmbH & Co. KG, Germany), or Turbofiner PLM mills (PALLMANN Maschinenfabrik GmbH & Co. KG, Germany). Gas classifier mills are also useful air-swept (gas-swept) impact mills, for example, the Hosokawa Alpine Air Classifier mill—ZPS Circoplex Hosokawa Micron Ltd., Cheshire, England. Other preferred mill-drying devices are flash mill dryers; they are commercially available, for example from Hosokawa under the trademark Drymeister (DMR). Other suitable mills and mill-type dryers are, for example hammer mills, screen-type mills, pin mills, or centrifugal impact mills, disk mills, or preferably classifier mills.

Air or nitrogen gas can be used for drying. In the process of the present invention the gas fed into the mill-drying device, more specifically the mill-drying chamber of the mill-drying device, typically has a temperature of 200° C. or less, preferably 160° C. or less, and in some embodiments of 130° C. or less, such as 120° C. or less, or even 110° C. or less. Typically, the gas fed into the mill-drying device has a temperature of 50° C. or more, preferably of 60° C. or more, more preferably of 65° C. or more. A gas stream having the above-mentioned temperature can be created in various ways. In one embodiment of the invention a fresh gas stream having the desired temperature can be fed into the mill-drying device. In another embodiment of the invention a recycled gas stream having the desired temperature is fed into the mill-drying device. For example, a gas stream can be separated from the ground and dried colloidal MCC, and the resulting solid-free gas stream, or a portion thereof, can be cooled in a cooling system, e.g., using water as coolant. This resulting cooled gas stream can be fed into the mill-drying device. Alternatively, the entire amount of cooled gas can be re-heated, e.g. in a natural gas burner. To bring the re-heated gas to the desired temperature for feeding into the mill-drying device, a separate stream of cold gas can be combined with the hot gas stream before feeding the gas stream into the mill-drying device.

The gas and the moist colloidal MCC stream are generally fed via separate inlets into the mill-drying chamber, typically gas from the bottom and moist colloidal MCC at a side entrance via a feed screw system connected to the mill-drying chamber resulting in an upward flow of colloidal MCC and gas, while colloidal MCC is being contacted with one or more grinding inserts, such as grinding pins, rods, bars, plates or disks inside the mill-drying chamber. Alternatively, the moist colloidal MCC can be fed into the gas stream and subsequently via the gas stream into the mill-drying chamber.

In a further embodiment, superheated vapor of a solvent, such as superheated steam, or a steam/inert gas mixture or a steam/air mixture can be used as heat-transfer gas and transport gas, as described in more detail in European Patent Applications EP 0 954 536 A1 and EP 1 127 910 A1.

In an embodiment of the invention, the moist colloidal microcrystalline cellulose which is provided for mill-drying in a mill-drying device is colloidal microcrystalline cellulose which has been obtained by co-attrition of microcrystalline cellulose with an attriting aid, such as an acid or an inorganic salt and/or with a protective colloid, such as one or more polysaccharides, which may be cellulose derivatives, preferably cellulose ethers, such as carboxymethyl cellulose (CMC), hydroxypropyl methylcellulose (HPMC) or methylcellulose (MC); or cellulose ether esters; or polysaccharides which may be isolated from plant exudates as from for example gum Arabic, gum ghatti, gum karaya, gum tragacanth; plant seeds such as starches, locust bean gum, guar gum; seaweed polysaccharides such as agar, carrageenan, furcelleran and alginates; microbial and/or fermentation products such as dextran, xanthan, pullulan; or pectins.

In a preferred embodiment the colloidal microcrystalline cellulose has been obtained by co-attrition of microcrystalline cellulose with a polysaccharide, preferably a cellulose ether, more preferably carboxymethyl cellulose (CMC), such as sodium carboxymethyl cellulose (sodium CMC).

In an embodiment of the invention, the moist colloidal microcrystalline cellulose which is provided for mill drying in a mill drying device is microcrystalline cellulose which has been co-attrited with a polysaccharide, preferably a cellulose ether, more preferably a carboxymethyl cellulose (CMC), wherein the weight ratio of MCC:polysaccharide is from 70:30 to 98:2, preferably from 75:25 to 95:5, such as from 78:22 to 92:8, more preferably from 80:20 to 90:10, such as from 81:19 to 90:10.

In an embodiment of the invention, the mill-dried colloidal microcrystalline cellulose comprises MCC and carboxymethyl cellulose (CMC), such as sodium carboxymethyl cellulose (sodium CMC).

In an embodiment of the invention, the mill-dried colloidal microcrystalline cellulose comprises MCC and carboxymethyl cellulose (CMC), wherein the ratio of MCC:CMC is from 70:30 to 98:2, preferably from 75:25 to 95:5, such as from 78:22 to 92:8, more preferably from 80:20 to 90:10, such as from 81:19 to 90:10.

The moist colloidal microcrystalline cellulose which is provided for mill-drying has a moisture content of from 20 to 75 percent, preferably from 30 to 75%, such as from 40 to 75%, such as from 45 to 75%, more preferably from 50 to 70%, such as from 55 to 65%, based on the total weight of the moist colloidal MCC. The moisture content is measured as the loss on drying. The loss on drying is determined according to USP (United States Pharmacopeia) 35 <731>‘Loss on Drying’.

In one embodiment of the invention, colloidal microcrystalline cellulose having a moisture content as disclosed above is directly obtained by partial depolymerization of cellulose and subsequent washing and co-processing, for example co-attrition, of MCC with at least one polysaccharide as described above.

In another embodiment of the invention, colloidal MCC and a liquid, such as water, can be mixed, such as kneaded, in a compounder to provide a colloidal microcrystalline cellulose having a moisture content as disclosed above.

The obtained moist colloidal MCC is subsequently subjected to mill-drying in a mill drying device according to the process of the present invention. The compounder preferably allows thorough and intense mixing. Useful compounders are, for example, granulators, kneaders, extruders, presses, or roller mills, wherein the mixture of the colloidal MCC and liquid is homogenized by applying shear forces and compounding, such as a twin-screw compounder. Co-rotating as well as counter-rotating machines are suitable. So-called divided trough kneaders with two horizontally arranged agitator blades that engage deeply with one another and that perform a mutual stripping action, as in the case of twin-screw compounders are particularly suitable. Suitable single-shaft, continuous kneaders include the so-called Reflector® compounders, which are high performance mixers of modular construction, consisting of a multi-part, heatable and coolable mixing cylinder and a unilaterally mounted blade mixer (manufacturer: Lipp, Germany). Also suitable are so-called pinned cylinder extruders or Stiftconvert® extruders (manufacturer: Berstorff, Germany). The pins incorporated in the housing serve as abutments to prevent the kneaded material rotating together with the shaft. Kneader mixers with so-called double-blade sigma stirrers (manufacturer: Fima, Germany) in a horizontal assembly are particularly suitable. The blades operate at different speeds and their direction of rotation can be reversed. A stirred vessel with a vertically arranged mixer shaft is also suitable if suitable flow baffles are mounted on the vessel wall in order to prevent the kneaded mass rotating together with the stirrer shaft, and in this way an intensive mixing action is imparted to the kneaded material (manufacturer: Bayer AG). Also suitable are double-walled mixing vessels with a planetary stirrer and inline homogenizer.

In an embodiment of the invention the gas is fed into a gas-swept mill-drying device at a flow rate of from 1000 to 4000 m³/h, preferably from 1100 to 3000 m³/h, such as from 1200 to 2800 m³/h, such as from 1400 to 2600 m³/h, such as from 1500 to 2500 m³/h, such as from 1600 to 2300 m³/h.

In an embodiment of the invention the gas is fed into a gas-swept mill-drying device at a flow rate of from 5 to 1000 m³ gas/kg colloidal MCC dr y, preferably from 10 to 500 m³ gas/kg colloidal MCC_{dry}, more preferably from 30 to 270 m³ gas/kg colloidal MCC_{dry}.

In one aspect of the invention the circumferential speed of the gas-swept mill-drying device is preferably not more than 220 m/s, such as not more than 200 m/s, such as not more than 150 m/s, such as not more than 130 m/s or not more than 120 m/s. In an aspect of the invention the circumferential speed of the gas-swept mill-drying device is preferably more than 20 m/s, such as more than 30 m/s, such as more than 40 m/s, such as more than 50 m/s. In an aspect of the invention the gas-swept mill-drying device is operated in such a manner that its circumferential speed is in a range from 30 to 130 m/s, more preferably from 50 to 120 m/s, such as from 60 to 120 m/s.

In one aspect of the invention the mill-drying device, preferably the gas-swept impact mill, is operated at preferably not more than 20,000 rpm (revolutions per minute), such as not more than 15,000 rpm, such as not more than 8000 rpm. In an aspect of the invention the mill-drying device is operated at more than 1000 rpm, such as more than 1200 rpm, or such as more than 1500 rpm.

In the mill-drying process of the present invention the moisture content of the produced colloidal MCC after mill-drying is typically less than 20 percent, such as up to 15 percent, such as up to 10 percent, preferably up to 5 percent, more preferably up to 4 percent, such as from 1-4 percent, such as 1.5-4, such as 2-4 or such as 2.5-3.5 percent, based on the total weight of the colloidal MCC.

Particle size and shape (LEFI, DIFI and EQPC) of a particulate colloidal MCC can be determined by a high-speed image analysis method which combines particle size and shape analysis of sample images. An image analysis method for complex powders is described in: W. Witt, U. Köhler, J. List, Current Limits of Particle Size and Shape Analysis with High Speed Image Analysis, PARTEC 2007. A high-speed image analysis system is commercially available from Sympatec GmbH, Clausthal-Zellerfeld, Germany as dynamic image analysis (DIA) system QICPIC™. The system analyses the shape of the particles and takes potential curliness of the particles into account. It provides a more accurate measurement (LEFI, DIFI and EQPC) of true particle sizes than other methods. The dynamic image analysis (DIA) system QICPIC™ is described in more detail by Witt, W., Köhler, U., List, J.: Direct Imaging of very fast Particles Opens the Application of Powerful (dry) Dispersion for Size and Shape Characterization, PARTEC 2004, Nuremberg, Germany.” The high-speed image analysis system is useful for measuring among others the following dimensional parameters of particles:

The EQPC (Equivalent Projected Circle Diameter) of the particle is defined as the diameter of a circle that has the same area as the projection area of the particle. The EQPC (50,3) is the median diameter of a Circle of Equal Projection Area and is defined as follows: All particle size distributions, e.g. the EQPC can be displayed and applied as number (0), length (1), area (2) or volume (3) distribution. The volume distribution of the EQPC is calculated as cumulative distribution Q. The volume distribution within the diameter of a Circle of Equal Projection Area value EQPC 50,3 is designated by the number 3 after the comma. The designation 50, reflecting the median value, stands for 50% of the EQPC of particle distribution being smaller than the given value in μm and 50% being larger. The 50% EQPC value is calculated by the image analyzer software.

The colloidal microcrystalline cellulose that is produced according the process of the present invention generally has a median EQPC (EQPC 50,3) of at least 10 micrometers, preferably at least 20 micrometers, more preferably at least 30 micrometers, such as at least 40 micrometers or such as at least 50 micrometers. The colloidal microcrystalline cellulose that is produced according the process of the present invention generally has a median EQPC (EQPC 50,3) of up to 400 micrometers, preferably up to 300 micrometers, more preferably up to 250 micrometers, such as up to 200 micrometers, such as up to 100 micrometers.

LEFI: The particle length LEFI is defined as the longest direct path that connects the ends of the particle within the contour of the particle. “Direct” means without loops or branches. For the purpose of the present invention the median LEFI is based on volume distribution of all particles in a given sample of a particulate colloidal microcrystalline cellulose. The median LEFI means that 50% of the LEFI of the particle distribution is smaller than the given value in μm and 50% is larger.

The colloidal microcrystalline cellulose that is produced according the process of the present invention generally has a median LEFI of at least 10 micrometers, preferably at least 40 micrometers, more preferably at least 60 micrometers, such as at least 70 micrometers or such as at least 80 micrometers. The colloidal microcrystalline cellulose that is produced according the process of the present invention generally has a median LEFI of up to 400 micrometers, preferably up to 300 micrometers, more preferably up to 200 micrometers, such as up to 150 micrometers, such as up to 120 micrometers.

DIFI: The particle diameter is calculated by dividing the projection area by the sum of all lengths of the branches of the particle skeleton. DIFI is calculated automatically by the software PAQXOS of the dynamic image analysis (DIA) system QICPIC™. For the calculation of DIFI the software PAQXOS is applying this method to those particles only that are completely within the image frame. For the purpose of the present invention the median DIFI is based on the volume distribution of all particles in a given sample of a particulate colloidal microcrystalline cellulose. The median DIFI means that 50% of the DIFI of the particle distribution is smaller than the given value in μm and 50% is larger.

The colloidal microcrystalline cellulose that is produced according the process of the present invention generally has a median DIFI of at least 10 micrometers, preferably at least 20 micrometers, more preferably at least 25 micrometers, such as at least 30 micrometers or such as at least 40 micrometers. The colloidal microcrystalline cellulose that is produced according the process of the present invention generally has a median DIFI of up to 400 micrometers, preferably up to 300 micrometers, more preferably up to 200 micrometers, such as up to 100 micrometers, such as up to 80 micrometers, or such as up to 70 micrometers.

Bulk density (BD) as used herein is defined as the ratio of apparent volume to mass of the material taken, called untapped bulk density, and also the ratio of tapped volume to mass of material taken, called tapped bulk density. A useful procedure for measuring these bulk densities is described in United States Pharmacopeia 24, Test 616 “Bulk Density and Tapped Density,” United States Pharmacopeia Convention, Inc., Rockville, Maryland, 1999. The colloidal microcrystalline cellulose that is produced according the process of the present invention generally has an untapped bulk density of at least 200 g/L, preferably of at least 300 g/L, more preferably of at least 400 g/L, and most preferably at least 500 g/L. In some embodiments of the invention, the colloidal microcrystalline cellulose even has an untapped bulk density at least 550 g/L, or even at least 600 g/L. The colloidal microcrystalline cellulose that is produced according the process of the present invention generally has an untapped bulk density of up to 2000 g/L, preferably up to 1500 g/L, more preferably up to 1200 g/L, such as up to 1000 g/L, such as up to 900 g/L, such as up to 800 g/L. The colloidal microcrystalline cellulose that is produced according the process of the present invention generally has a tapped bulk density of at least 300 g/L, preferably of at least 400 g/L, more preferably of at least 500 g/L, most preferably of at least 600 g/L or at least 700 g/L. The colloidal microcrystalline cellulose that is produced according the process of the present invention generally has a tapped bulk density of up to 2000 g/L, preferably up to 1500 g/L, more preferably up to 1200 g/L, such as up to 1000 g/L, such as up to 900 g/L.

The Carr index C is an indication of the compressibility of a powder. It is calculated by the formula C=100*(BD tapped−BD untapped)/BD tapped, wherein “BD tapped” is the tapped bulk density of a powder and “BD untapped” is the untapped bulk density of a powder. The Carr index is represented as a percentage. The Carr index is frequently used in the pharmaceutical science as an indication of the flowability of a powder. A Carr index of greater than 30 is usually an indication of poor flowability of a powder.

Viscosity measurements were conducted by a flow curve method, wherein the viscosity is measured as a function of shear rate. 2 wt.-% dispersions of colloidal MCC in water were prepared by adding deionized water having a temperature of 20° C. to a Waring blender model 8011ES (Model HGB2WTS3). Colloidal MCC was added and the Waring blender was turned on (low shear, level 1) for 15 sec followed by 2 min of shear at level 2 (high shear). The dispersion was transferred to a CC27 geometry (cup+bob geometry) of a Physica MCR501 rheometer with peltier system (Anton Paar Physica, Ostfildern, Germany) thermostated at 20° C. Steady shear experiments were performed, and the viscosities were measured in a flow curve experiment over a shear rate region of 0,1-1000 s-1 with 5 measurement points for each decade (logarithmic scale).

Two flow curves were established:

Viscosity measurements for the first flow curve were performed 5 minutes after the dispersion of colloidal MCC was added to the geometry (First flow curve, for determination of the viscosity, denoted ‘viscosity’ or ‘initial viscosity’).

After the viscosity measurements for the first flow curve were performed, the dispersion of colloidal MCC was kept for 24 h at 20° C. without stirring, after which viscosity measurements for the second flow curve were performed (second flow curve, for determination of the ‘24 h viscosity’).

In the present context, the ‘viscosity’ is defined as the viscosity read from the first flow curve at the shear rate of 2.51 s-1. In the present context the term ‘initial viscosity’ may be used interchangeably with the term ‘viscosity’.

In the present context, the ‘24 h viscosity’ is defined as the viscosity read from the second flow curve at the shear rate of 2.51 s-1.

In a preferred embodiment the colloidal microcrystalline cellulose that is produced according the process of the present invention generally has a viscosity of at least 1000 mPa s, preferably at least 1500 mPa s; more preferably at least 2000 mPa s; such as at least 2500 mPa s, such as at least 3000 mPa s measured as a 2 weight-% dispersion in water at 20° C. according to flow curve method at a shear rate of 2.51 s-1. In an embodiment the colloidal microcrystalline cellulose that is produced according the process of the present invention generally has a viscosity of up to 40000 mPa s, preferably up to 20000 mPa s, more preferably up to 10000 mPa s, measured as a 2 weight-% dispersion in water at 20° C. according to flow curve method at a shear rate of 2.51 s-1. The colloidal microcrystalline cellulose is preferably obtained by co-attrition of microcrystalline cellulose with a polysaccharide, more preferably a cellulose ether, and most preferably with carboxymethyl cellulose (CMC), before it is subjected to the mill-drying process of the present invention.

In an embodiment the colloidal microcrystalline cellulose that is produced according the process of the present invention has a ratio (initial viscosity):(24 h viscosity) of at least 0.28, typically at least 0.30, preferably of at least 0.4, such as at least 0.6, more preferably of at least 0.8, such as 0.9, such as of at least 1.0, measured as 2 weight-% dispersions in water at 20° C. according to flow curve method at a shear rate of 2.51 s-1.

In an embodiment the colloidal microcrystalline cellulose that is produced according the process of the present invention has a ratio (initial viscosity):(24 h viscosity) of up to 3.0, such as up to 2.8, such as up to 2.5, preferably up to 2.4, such as up to 2.3, such as up to 2.2, such as of up to 2.0, measured as 2 weight-% dispersions in water at 20° C. according to flow curve method at a shear rate of 2.51 s-1. This colloidal microcrystalline cellulose preferably has a viscosity of at least 1000 mPa s and up to 40000 mPa s, measured as a 2 weight-% dispersion in water at 20° C. according to flow curve method at a shear rate of 2.51 s-1. More preferably, this colloidal microcrystalline cellulose has a preferred viscosity as indicated above.

In an embodiment, the colloidal microcrystalline cellulose, comprising MCC and carboxymethyl cellulose (CMC), wherein the ratio of MCC:CMC is from 70:30 to 98:2, preferably from 75:25 to 95:5, such as from 78:22 to 92:8, more preferably from 80:20 to 90:10, such as from 81:19 to 90:10, that is produced according the process of the present invention generally has a viscosity of at least 1000 mPa s, preferably at least 1500 mPa s; more preferably at least 2000 mPa s; such as at least 2500 mPa s, such as at least 3000 mPa s, measured as a 2 weight-% dispersion in water at 20° C. according to flow curve method at a shear rate of 2.51 s-1.

In an embodiment, the colloidal microcrystalline cellulose, comprising MCC and carboxymethyl cellulose (CMC), wherein the ratio of MCC:CMC is from 70:30 to 98:2, preferably from 75:25 to 95:5, such as from 78:22 to 92:8, more preferably from 80:20 to 90:10, such as from 81:19 to 90:10, that is produced according the process of the present invention generally has a viscosity of up to 40000 mPa s, preferably up to 20000 mPa s, more preferably up to 10000 mPa s measured as a 2 weight-% dispersion in water at 20° C. according to flow curve method at a shear rate of 2.51 s-1.

### EXAMPLES

### Comparative Example

The colloidal MCC of the Comparative Example consists of colloidal grade MCC with 11.3-18.8% CMC which has been obtained by spray-drying a slurry of ca. 85% (w/w) water and ca. 15% (w/w) (colloidal grade MCC with 11.3-18.8% CMC). It is commercially available under the trademark Avicel® CL 611.

### General Description of Examples 1-19

Colloidal MCC wetcake material used in Examples 1-19 was obtained from commercial microcrystalline cellulose manufacturing process of Avicel CL 611 (colloidal grade MCC with 11.3-18.8 wt. % Sodium CMC) having a moisture content of 55-56%, based on the total weight of the colloidal microcrystalline cellulose. In examples 1-12 and 14, colloidal MCC wetcake material was manually transferred to the dosing vessel (to reach minimum level required for continuous and stable feeding) located before a milling-drying unit. From the dosing vessel wetcake was transported continuously via feeding screw located at the bottom of the vessel. The material was forced through a perforated plate (d=14 mm of voids) directly into the side of an Ultrarotor II “S” impact mill (Altenburger Maschinen Jaeckering GmbH, Hamm, Germany) between the first and second grinding stage. The mill was equipped with seven grinding stages, which were standard grinding bars, and no sifters. The rotor of the impact mill was operated at a circumferential speed up to 114 m/s (or 4444 rpm=100%). Variations of mill rotation speed are summarized in Table 2, Examples 5-9. A specific gas flow system used herein was a closed loop system applying nitrogen as carrier and drying gas. Variations of gas flow are summarized in Table 3, Examples 10-11. Temperature of the gas stream was controlled via a natural gas burner and a gas cooling system using cold water as coolant. The resulting gas temperatures of the respective gas streams are listed for each example. The impact of gas inlet temperature on the viscosity is summarized in Table 1, Examples 1-4. The colloidal microcrystalline cellulose samples were directly collected after the milling-drying step by sieving through an Allgaier tumbler screening machine (Allgaier, Uhingen, Germany) equipped with a 500 μm sieve. The final moisture content was less than 6.3% by weight, based on the total weight of the colloidal microcrystalline cellulose.

The tapped (value was measured with 180× tapping) and untapped bulk density of dried colloidal microcrystalline cellulose materials was measured using Hosokawa Powder Characteristics Tester: Model PT-S available from Hosokawa Micron, Osaka Japan.

Values of Carr Index (as percentage) were calculated as “(Tapped bulk density−Untapped bulk density)/Tapped bulk density·100”.

Particle size of dried colloidal microcrystalline cellulose samples, represented as median DIFI (X50), median LEFI (X50) and median EQPC (X50), were measured by an image analyzer (high speed image analyzer sensor QICPIC, Sympatec, Germany, with dry disperser RODOS/L with an inner diameter of 4 mm and dry feeder VIBRI/L and Software WINDOXS, Vers. 5.8.2.1 and M7 lens).

Tables 4-5 Examples 13, 15, 16-19 disclose the impact of compounder on the viscosity of colloidal microcrystalline cellulose. Examples 12 and 14 were run without compounder and without disintegration vessel for comparison. A commercially available continuous compounder with heating and cooling jacket was used to knead the colloidal MCC wetcake without (Table 4, Examples 13, 15) or with water addition (Table 5, Examples 16-19). The compounder jacket was supplied with a fluid of 25° C. The fluid in the compounder jacket was used to adapt the temperature of the wet colloidal microcrystalline cellulose material prior to drying and grinding and to ensure sufficient mixing of the wetcake with and without added water. Fresh water at 25° C. was added to increase moisture of the wetcake to investigate the impact of moisture on the viscosity, findings are summarized in Table 5, Example 16-19. Table 4, Examples 12-15 discloses the impact of compounder on wetcake as received from commercial plant, meaning that the wetcake was only kneaded in the compounder without adding fresh water. In the Tables 4-5, Examples 13, 15, 16-19 kneaded wetcake material passed through a disintegration unit (Paddle Mixer purchased from Altenburger Maschinen Jaeckering GmbH, Hamm, Germany) before it reached the dosing vessel. From the dosing vessel, the wetcake was mill-dried as described above.

Examples 1-4, Table 1, Variations of gas inlet temperature (° C.): Flow through the mill: 2200 m3/h; Mill rpm: 2223 rpm (A) or 4444 rpm (B); Solid feed: 11-14 kg/h (value calculated on dry solid after milling-drying); Wetcake moisture: 56%; No compounder; no disintegration vessel.

TABLE 1

| | | | | | | | Viscosity | | | Moisture |
|---|---|---|---|---|---|---|---|---|---|---|
| | Gas | | | | | | (measured | | | after |
| | Inlet | | | | Untapped/tapped | | after | 24 h | (viscosity): | mill- |
| | T | Median DIFI | Median LEFI | Median EQPC | density | Carr | 5 min) | Viscosity | (24 h | drying, |
| Ex. | (° C.) | (μm) | (μm) | (μm) | (g/L) | Index | (mPas) | (mPas) | viscosity) | (%) |
| Compa- | NA | 41.3 | 74.9 | 59.2 | 540/754 | 28.4 | 469 | 1910 | 0.25 | 3.8 |
| rative | | | | | | | | | | |
| 1 (A) | 75.9 | 176.6 | 371.3 | 291.1 | 750/830 | 9.6 | 3090 | 2080 | 1.48 | 6.3 |
| 2 (A) | 127.5 | 123.6 | 276.3 | 208.2 | 758/838 | 9.5 | 4660 | 3290 | 1.41 | 2.7 |
| 3 (B) | 74.9 | 45.1 | 82.2 | 65.2 | 556/766 | 27.4 | 2830 | 2720 | 1.04 | 3.5 |
| 4 (B) | 107.3 | 43.9 | 81.9 | 63.6 | 549/776 | 29.2 | 2840 | 1290 | 2.20 | 1.6 |

Examples 5-9, Table 2, Variations of mill rotation speed (rpm) Mill rpm 50%=2223 rpm; 100%=4444 rpm: T gas inlet temperature: 75° C.; Flow through the mill: 2200 m3/h; Solid feed: 11-14 kg/h (Value calculated on dry solid after milling-drying); Wetcake moisture: 56%; No compounder; no disintegration vessel.

TABLE 2

| | | | | | | | | | | Moisture |
|---|---|---|---|---|---|---|---|---|---|---|
| | | | | | | | | | | after |
| | Mill | Median | Median | | | | viscosity | 24 h | (viscosity): | mill- |
| | rpm | DIFI | LEFI | Median EQPC | Untapped/tapped | Carr | (measured | Viscosity | (24 h | drying, |
| Ex. | (%) | (μm) | (μm) | (μm) | density(g/L) | Index | after 5 | (mPas) | viscosity) | (%) |
| Com- | NA | 41.3 | 74.9 | 59.2 | 540/754 | 28.4 | 469 | 1910 | 0.25 | 3.8 |
| parative | | | | | | | | | | |
| 5 | 50 | 176.6 | 371.3 | 291.1 | 750/830 | 9.6 | 3090 | 2080 | 1.49 | 6.3 |
| 6 | 60 | 126.3 | 275.1 | 209.7 | 731/822 | 11.1 | 3550 | 3310 | 1.07 | 5.1 |
| 7 | 70 | 72.9 | 155.9 | 117.1 | 646/812 | 20.4 | 3070 | 3060 | 1.00 | 3.7 |
| 8 | 90 | 51.5 | 99.3 | 76.9 | 581/783 | 25.8 | 2570 | 2800 | 0.92 | 3.2 |
| 9 | 100 | 45.1 | 82.2 | 65.2 | 556/766 | 27.4 | 2830 | 2720 | 1.04 | 3.5 |

Examples 10-11, Table 3, Variations of flow through mill (m3/h): T gas inlet temperature: 75° C.; Mill rpm=100%, (Mill rpm 50%=2223 rpm; 100%=4444 rpm); Solid feed: 11 kg/h (Value calculated on dry solid after milling-drying); Wetcake moisture: 56%; No compounder; no disintegration vessel.

TABLE 3

| | | | | | | | | | | Moisture |
|---|---|---|---|---|---|---|---|---|---|---|
| | Flow | | | | | | viscosity | | | after |
| | through | Median | Median | Median | | | (measured | 24 h | (viscosity): | mill- |
| | mill, | DIFI | LEFI, | EQPC, | Untapped/tapped | Carr | after 5 min) | Viscosity | (24 h | drying, |
| Ex. | (m3/h) | (μm) | (μm) | (μm) | density, (g/L) | Index | (mPas) | (mPas) | viscosity) | (%) |
| Compa- | NA | 41.3 | 74.9 | 59.2 | 540/754 | 28.4 | 469 | 1910 | 0.25 | 3.8 |
| rative | | | | | | | | | | |
| 10 | 1600 | 40.0 | 67.5 | 55.9 | 543/751 | 27.7 | 3220 | 3190 | 1.01 | 3.5 |
| 11 | 2200 | 45.1 | 82.2 | 65.2 | 556/766 | 27.1 | 2830 | 2720 | 1.04 | 3.1 |

Examples 12-15, Table 4, Variations of compounder: T gas inlet temperature: 127(A)/105(B) ° C.; Flow through mill: 2200 m3/h; Mill rpm=50(A)/100(B) % (Mill rpm 50%=2223 rpm; 100%=4444 rpm); Solid feed: 11 kg/h (Value calculated on dry solid after milling-drying); Wetcake moisture: 56%.

TABLE 4

| | | | | | | | | | | Moisture |
|---|---|---|---|---|---|---|---|---|---|---|
| | | | | | | | viscosity | | | after |
| | | Median | Median | Median | | | (measured | 24 h | (viscosity): | mill- |
| | | DIFI | LEFI | EQPC | Untapped/tapped | Carr | after 5 min), | Viscosity | (24 h | drying, |
| Ex. | Compounder | (μm) | (μm) | (μm) | density (g/) L | Index | (mPas) | (mPas) | viscosity) | (%) |
| Com- | NA | 41.3 | 74.9 | 59.2 | 540/754 | 28.4 | 469 | 1910 | 0.25 | 3.8 |
| parative, | | | | | | | | | | |
| Avicel | | | | | | | | | | |
| CL611 | | | | | | | | | | |
| 12 (A) | no | 123.6 | 276.3 | 208.2 | 758/838 | 9.5 | 4660 | 3290 | 1.42 | 2.7 |
| | compounder; | | | | | | | | | |
| | no | | | | | | | | | |
| | disintegration | | | | | | | | | |
| | vessel | | | | | | | | | |
| 13 (A) | with | 124.1 | 267.3 | 205.7 | 731/835 | 12.5 | 4580 | 3900 | 1.17 | 2.9 |
| | compounder; | | | | | | | | | |
| | with | | | | | | | | | |
| | disintegration | | | | | | | | | |
| | vessel | | | | | | | | | |
| 14 (B) | no | 43.9 | 81.9 | 63.6 | 549/776 | 29.2 | 2840 | 1290 | 2.20 | 1.6 |
| | compounder; | | | | | | | | | |
| | no | | | | | | | | | |
| | disintegration | | | | | | | | | |
| | vessel | | | | | | | | | |
| 15(B) | with | 43.4 | 78.8 | 62.7 | 546/764 | 28.5 | 4570 | 3250 | 1.41 | 1.9 |
| | compounder; | | | | | | | | | |
| | with | | | | | | | | | |
| | disintegration | | | | | | | | | |
| | vessel | | | | | | | | | |

Examples 16-19, Table 5, Variations of wetcake moisture (%): T gas inlet temperature: 129° C.; (A) or 102° C.; (B) Flow through mill: 2200 m3/h; Mill rpm=50(A)/100(B) %, (Mill rpm 50%=2223 rpm; 100%=4444 rpm); Solid feed: 10-11 kg/h (Value calculated on dry solid after milling-drying) Run with compounder; with disintegration vessel.

TABLE 5

| | | | | | | | Viscosity | | | Moisture |
|---|---|---|---|---|---|---|---|---|---|---|
| | Wetcake | Median | Median | Median | Untapped/ | | (measured | 24 h | (viscosity): | after |
| | moisture | DIFI | LEFI | EQPC | tapped density | Carr | after 5 | Viscosity | (24 h | mill-drying |
| Ex. | (%) | (μm) | (μm) | (μm) | (g/L) | Index | min) (mPas) | (mPas) | viscosity) | (%) |
| Com- | NA | 41.3 | 74.9 | 59.2 | 540/754 | 28.4 | 469 | 1910 | 0.25 | 3.8 |
| parative, | | | | | | | | | | |
| Avicel | | | | | | | | | | |
| CL611 | | | | | | | | | | |
| 16 (A) | 56.3 | 124.1 | 267.3 | 205.7 | 731/835 | 12.5 | 4580 | 3900 | 1.17 | 2.9 |
| 17 (A) | 64.2 | 130.0 | 285.5 | 218.1 | 626/820 | 23.7 | 4100 | 2870 | 1.43 | 2.8 |
| 18 (B) | 56.3 | 43.4 | 78.8 | 62.7 | 546/764 | 28.5 | 4570 | 3250 | 1.41 | 2.0 |

The results disclosed in the Tables 1-5 show that the process of the present invention enables the production of mill-dried colloidal microcrystalline cellulose exhibiting a higher viscosity (higher initial viscosity) and a higher 24 h viscosity, measured as a 2 weight-% dispersion in water at 20° C. according to flow curve method at a shear rate of 2.51 s-1, than the corresponding spray-dried colloidal microcrystalline cellulose.

The results disclosed in the Tables 1-5 illustrate that mill-dried colloidal microcrystalline cellulose of the present invention exhibit a smaller relative change of viscosity during 24 h, compared to the relative change of viscosity during 24 h of the spray-dried colloidal MCC, measured as a 2 weight-% dispersion in water at 20° C. according to flow curve method at a shear rate of 2.51 s-1. Thus, the relative change in viscosity of spray-dried colloidal MCC was 307% ((1910-469)/469*100); whereas the relative change in viscosity of the of viscosity in the examples of the present invention was up to (−) 55% ((24 h viscosity−initial viscosity)/initial viscosity*100). This is an indication that the colloidal MCC of the present invention reaches its final viscosity faster than the commercial spray-dried colloidal MCC. Similarly, the ratio of the viscosity (measured after 5 minutes) to the 24 h viscosity illustrate that the mill-dried colloidal microcrystalline cellulose of the present invention exhibits a smaller change of viscosity during 24 h, compared to the change of viscosity during 24 h of the spray-dried colloidal MCC. Thus, the ratio of (initial viscosity):(24 h viscosity) of the Comparative Example (spray-dried colloidal MCC) is 0.25, whereas the ratio of (initial viscosity):(24 h viscosity) of the mill-dried colloidal MCC of Examples 1-18 is from 1 to 2.2.

The results disclosed in the Tables 1-5 illustrate that mill-drying of colloidal microcrystalline cellulose can provide mill-dried colloidal microcrystalline cellulose having similar particle size distribution (LEFI, DIFI and EQPC), tapped/untapped bulk density, and moisture content as the corresponding spray-dried colloidal microcrystalline cellulose.

Additionally, the results disclosed in the Tables 1-5 illustrate that mill-drying of colloidal microcrystalline cellulose can provide mill-dried colloidal microcrystalline cellulose having higher LEFI, DIFI and EQPC and a higher tapped/untapped bulk density, while keeping a similar moisture content as the corresponding spray-dried colloidal microcrystalline cellulose.

Spray-dried colloidal microcrystalline cellulose is generally obtained by spray-drying a slurry of colloidal MCC having a moisture content of ca. 80 to 90 percent, based on the total weight of the slurry of colloidal MCC. The colloidal microcrystalline cellulose prepared according to the above examples is obtained by mill-drying moist colloidal MCC having a moisture content of ca. 50-60 percent. The mill-dried colloidal MCC as disclosed in tables 1-5 is thus obtained with a substantially reduced consumption of water and energy as compared to spray-dried colloidal MCC.

1. A process for producing mill dried colloidal microcrystalline cellulose (MCC) comprising the steps of
a) providing colloidal MCC having a moisture content of from 20 to 75 percent, based on the total weight of the moist colloidal MCC; and
b) mill-drying the moist colloidal MCC in a single device capable of milling and drying in combination.

2. The process according to claim 1, wherein the produced mill-dried colloidal microcrystalline cellulose has a moisture content of less than 20% by weight, based on the total weight of the produced mill-dried colloidal MCC.

3. The process according to claim 1, wherein colloidal MCC provided in step a) has a moisture content of from 50 to 70 percent, based on the total weight of the moist colloidal MCC.

4. The process according to claim 1, wherein the produced mill-dried colloidal microcrystalline cellulose has a viscosity of at least 1000 mPa s, measured as a 2 weight-% dispersion in water at 20° C. at a shear rate of 2.51 s-1.

5. The process according to claim 1, wherein the produced mill-dried colloidal microcrystalline cellulose has a median Equivalent Projected Circle Diameter (EQPC) of up to 400 micrometers, a median length of particle (LEFT) of up to 400 micrometers, a median diameter of particle (DIFI) of up to 400 micrometers, or a combination thereof.

6. The process according to claim 1, wherein the device capable of milling and drying in combination is a gas-swept impact mill or a flash mill dryer.

7. The process according to claim 1, wherein colloidal MCC provided in step a) is obtained by co-processing of microcrystalline cellulose with an attriting aid or a protective colloid or both.

8. The process according to claim 1, wherein the colloidal MCC provided in step a) is obtained by co-processing of microcrystalline cellulose with a polysaccharide.

9. The process according to claim 8, wherein the polysaccharide is carboxymethyl cellulose (CMC).

10. The process according to claim 8, wherein the weight ratio MCC: polysaccharide is from 70:30 to 98:2.

11. Colloidal microcrystalline cellulose producible by the process according to claim 1.

12. Colloidal microcrystalline cellulose according to claim 11, wherein said colloidal microcrystalline cellulose has a ratio (initial viscosity):(24 h viscosity), measured as 2 weight-% dispersions in water at 20° C. at a shear rate of 2.51 s-1, of at least 0.28.

13. Colloidal microcrystalline cellulose wherein said colloidal microcrystalline cellulose has a moisture content of less than 20% by weight, based on the total weight of the colloidal microcrystalline cellulose including moisture, and wherein said colloidal microcrystalline cellulose has a ratio (initial viscosity):(24 h viscosity), measured as 2 weight-% dispersion in water at 20° C. at a shear rate of 2.51 s-1, of at least 0.4.

14. The colloidal microcrystalline cellulose of claim 13 having a viscosity of at least 1000 mPa s, measured as a 2 weight-% dispersion in water at 20° C. at a shear rate of 2.51 s-1.

15. A food, beverage, pharmaceutical or personal care product comprising the colloidal microcrystalline cellulose according to claim 11.

16. A food, beverage, pharmaceutical or personal care product comprising the colloidal microcrystalline cellulose according to claim 13.
